(19) United States
(12) Patent Application Publication
(10) Pub. No.: US 2024/0309218 A1
(43) Pub. Date: Sep. 19, 2024

(54) VANADIUM OXIDE NANOPARTICLE-BASED INK COMPOSITIONS

(71) Applicant: King Abdullah University of Science and Technology, Thuwal (SA)

(72) Inventors: Mohammad VASEEM, Thuwal (SA); Shuai YANG, Thuwal (SA); Atif SHAMIM, Thuwal (SA)

(21) Appl. No.: 18/671,454

(22) Filed: May 22, 2024

Related U.S. Application Data
(63) Continuation of application No. 16/982,689, filed on Sep. 21, 2020.
(60) Provisional application No. 62/646,017, filed on Mar. 21, 2018.
(60) Provisional application No. 62/724,916, filed on Aug. 30, 2018.

(51) Int. Cl. C09D 1/00; B41M 5/00; B41M 7/00; C09D 11/38

(52) U.S. Cl. CPC C09D 1/00; B41M 5/0023; B41M 7/009; C09D 11/38; Y10T 428/24893

(57) ABSTRACT

Embodiments of the present disclosure describe ink compositions comprising a plurality of vanadium oxide nanoparticles and one or more carrier solvents. Embodiments of the present disclosure further describe methods of preparing ink compositions, methods of printing the ink compositions, RF devices and/or components incorporating the ink compositions, and the like.

### BACKGROUND

Tunable or reconfigurable components are becoming increasingly important due to proliferation of multi-band and multi-functional wireless devices. Several kinds of tuning and switching mechanisms are being explored such as P-I-N diodes, transistor based switches, micro-electro-mechanical systems (MEMS) switches, varactors, and ferrite and ferro-electric based devices. Each of these technologies has its own sets of advantages and disadvantages, however, one issue is common to them all, i.e., they are all based on complex subtractive photolithographic processes that are not only expensive and time consuming, but also result in substantial material wastage.

With the surge in additive manufacturing (inkjet, screen, and 3D printing)—which is extremely low in cost, completely digital, and highly suitable for rapid prototyping or large-scale manufacturing—it would be beneficial if switches could also be realized through additive manufacturing. However, there are no functional inks currently available in the market which can become a base material for printing switches. Development of functional inks, which can tune their electrical, material, or optical properties with external stimuli, such as temperature, light, applied field, or voltage, would be a significant advancement for low-cost printable switchable and reconfigurable devices.

### SUMMARY

In general, embodiments of the present disclosure describe ink compositions, methods of making ink compositions, methods of printing the ink compositions, and the like.

Accordingly, embodiments of the present disclosure describe an ink composition comprising a plurality of vanadium oxide nanoparticles and one or more carrier solvents.

Embodiments of the present disclosure further describe a method of preparing an ink composition comprising contacting a plurality of vanadium oxide nanoparticles and one or more carrier solvents to form a solution; and mixing the solution sufficient to distribute the vanadium dioxide nanoparticles in the solution.

Embodiments of the present disclosure further describe a method of printing an ink composition comprising printing one or more layers of a switchable ink composition onto a substrate, wherein the switchable ink composition includes a plurality of vanadium oxide nanoparticles and one or more carrier solvents, and heating the printed switchable ink composition to or at a select temperature.

Embodiments of the present disclosure further describe RF devices comprising the ink compositions of the present disclosure.

The details of one or more examples are set forth in the description below. Other features, objects, and advantages will be apparent from the description and from the claims.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1 is a flowchart of a method of preparing an ink composition, according to one or more embodiments of the present disclosure.

FIG. 2 is a flowchart of a method of printing an ink composition, according to one or more embodiments of the present disclosure.

FIGS. 3A-3D illustrate XRD spectra of (a) as-prepared VO₂ nanoparticles, (b) after annealing at about 300° C. for about 3 h in vacuum, (c) DSC analysis, and (d) SEM image of annealed VO₂ nanoparticles, with the inset in (d) showing the camera image of as-formulated VO₂ ink, according to one or more embodiments of the present disclosure.

FIG. 4 is a schematic diagram of a fabrication process, according to one or more embodiments of the present disclosure.

FIGS. 5A-5C are images of a printed (A) reference CPW line (B) with VO₂ film and (C) a zoomed-in view of the CPW line, according to one or more embodiments of the present disclosure.

FIG. 6 is a graphical view of measured DC resistance of printed VO₂ film, according to one or more embodiments of the present disclosure.

FIG. 7 is a graphical view of electrical switching of printed VO₂ film, according to one or more embodiments of the present disclosure.

FIG. 8 is a graphical view of measured S21 of the printed shunt switches at about room temperature and about 100° C., according to one or more embodiments of the present disclosure.

FIG. 9 is a graphical view of measured Sn of the printed shunt switches at about room temperature and about 100° C., according to one or more embodiments of the present disclosure.

FIGS. 10A-10B are (A) an image of an as-fabricated PIFA antenna prototype and (B) a graphical view of measured reflection coefficient of the antenna with VO₂ switch ON/OFF, according to one or more embodiments of the present disclosure.

### DETAILED DESCRIPTION

The invention of the present disclosure relates to ink compositions. In particular, the invention of the present disclosure relates to functional ink compositions including a phase-change material, such as vanadium oxide nanoparticles. For example, in an embodiment, the ink compositions may comprise, among other things, vanadium dioxide nanoparticles and one or more carrier solvents. One or more properties of the ink compositions (e.g., electrical, material, and/or optical properties, among other properties) may be tuned in response to one or more external stimuli, such as temperature, light, applied field, and/or applied voltage, among others. For example, the ink compositions may undergo a phase transition at a critical temperature (e.g., a temperature ranging from about 65° C. to about 70° C.), such that they exhibit insulating or insulating-like properties at about room temperature and conductive or conductive-like properties at temperatures greater than about the critical temperature. The ink compositions may exhibit this insulator-to-conductor (ICT) transition in a reversible manner in response to thermal tuning.

The ink compositions described herein may be used in additive manufacturing processes (e.g., inkjet, screen, 3D printing, etc.) to produce switchable and/or reconfigurable radio frequency (RF)-microwave devices and components thereof. For example, the ink compositions may be incorporated into manufacturing processes to produce fully printed switchable and reconfigurable RF-microwave devices and components thereof. The advantages of ink compositions capable of use in additive manufacturing processes may include, among other things, pico-liter drop of printing at site of interest in a digital manner, a wide range of substrates for printing, large area printing, and no or limited material wastage. In addition, the ink compositions may reduce the cost of manufacturing RF-microwave devices/components. For example, conventional methods of fabricating RF devices require expensive and complex thin film microfabrication techniques to deposit vanadium dioxide, such as pulsed laser deposition (PLD), where vanadium dioxide must be deposited at ultra-high vacuum pressures (8×10⁻⁶ Torr) and high temperatures (>550° C.). Conversely, the ink compositions of the present disclosure may be printed under comparatively much milder conditions.

Accordingly, the invention of the present disclosure also relates to methods of printing the ink compositions. The methods may comprise, for example, printing one or more layers of a vanadium oxide nanoparticle-based ink onto a substrate and heating the printed vanadium oxide-based ink to obtain, for example, a desired film quality. In this way, ink compositions may be used to produce a wide variety of switchable and/or reconfigurable RF devices and components thereof, such as, switches, antennas, phase shifters, modulators, delay lines, filters, matching networks, tunable loads, sensors, and detectors, among other things.

### Definitions

The terms recited below have been defined as described below. All other terms and phrases in this disclosure shall be construed according to their ordinary meaning as understood by one of skill in the art.

As used herein, “contacting” refers to the act of touching, making contact, or of bringing to close or immediate proximity, including at the cellular or molecular level, for example, to bring about a physiological reaction, a chemical reaction, or a physical change (e.g., in solution, in a reaction mixture, in vitro, or in vivo). Contacting may refer to bringing two or more components in proximity, such as physically, chemically, electrically, or some combination thereof. Mixing is an example of contacting.

As used herein, “mixing” refers to an example and/or form of contacting and may include any process of distributing one component in and/or within one or more other components. For example, the “mixing” may include stirring (e.g., using a stir bar) to form one or more of a mixture, distribution, dispersion, and suspension, among other things.

As used herein, “printing” refers to any process for contacting ink and a substrate. For example, “printing” may include ejecting and/or depositing one or more droplets of ink onto a substrate in any form or pattern. The “printing” may be used to form one or more layers of the ink composition.

As used herein, “heating” refers to increasing a temperature. For example, heating may refer to exposing or subjecting any object, material, etc. to a temperature that is greater than a current or previous temperature. Heating may also refer to increasing a temperature of any object, material, etc. to a temperature that is greater than a current or previous temperature of the object, material, etc.

As used herein, “annealing” refers to heating to or at a select temperature. For example, “annealing” may include heating to or at a temperature ranging from about 100° C. to about 500° C., optionally under vacuum. Annealing may further include heating to or at a select temperature for a select period of time (e.g., from about 1 h to about 6 h) and slowly cooling thereafter. Annealing conditions may include annealing in air and/or vacuum.

As used herein, “ink” or “ink composition” generally refers to any material that may be applied using any printing technique, such as inkjet printing, 3D printing, etc.

As used herein, “vanadium oxide” generally refers to any transition metal oxide containing vanadium. For example, “vanadium oxide” may include, but is not limited to, one or more of V₂O₅, V₂O₃, and VO₂.

As used herein, “radio frequency” or “RF” refers to electromagnetic wave frequencies within a predefined range. For example, “radio frequency” may include electromagnetic wave frequencies ranging from about 20 kHz to about 300 GHz. The term “radio frequency” includes, among other things, microwaves. As used herein, “microwave” generally refers to electromagnetic wave frequencies ranging from about 300 MHz to about 300 GHz, which generally includes the ultra high frequency (UHF) to extremely high frequency (EHF) bands.

As used herein, “RF device” and “RF devices” refers to any RF device including any components of an RF device.

Embodiments of the present disclosure describe ink compositions. The ink compositions may comprise a plurality of vanadium oxide nanoparticles and one or more carrier solvents. In an embodiment, the ink composition may be provided as a mixture, wherein the mixture includes a plurality of vanadium oxide nanoparticles mixed with a carrier solvent. In an embodiment, the ink composition may be provided as a dispersion, wherein the dispersion includes a plurality of vanadium oxide nanoparticles dispersed in a carrier solvent. In an embodiment, the ink composition may be provided as a suspension, wherein the suspension includes a plurality of vanadium oxide nanoparticles suspended in a carrier solvent. These shall not be limiting, as the ink composition may be provided in any form other than a mixture, dispersion, and suspension.

The vanadium oxide nanoparticles may include any nanoparticle including vanadium and an oxide. For example, in many embodiments, the vanadium oxide nanoparticles may be characterized by one or more of the following chemical formulas: V₂O₅, V₂O₃, and VO₂. In preferred embodiments, the vanadium oxide nanoparticles may include vanadium dioxide (VO₂) nanoparticles. The vanadium oxide nanoparticles may be characterized by one or more crystalline structure phases. In many embodiments, the vanadium oxide nanoparticles may include vanadium dioxide nanoparticles in one or more of a monoclinic phase, tetragonal phase, and orthorhombic phase. For example, vanadium dioxide nanoparticles may be present as or transformed to one or more of a M1 (monoclinic), M1′ (monoclinic), R (tetragonal), O (orthorhombic), X (monoclinic) phase, and A phase. In preferred embodiments, the vanadium oxide nanoparticles include vanadium dioxide nanoparticles present as and/or transformed to one or more of a monoclinic phase and tetragonal phase. The vanadium oxide nanoparticles may be subjected to a treatment and/or pretreatment as described in more detail below. For example, in an embodiment, the vanadium oxide nanoparticles (e.g., as-prepared vanadium oxide nanoparticles) may be subjected to annealing at or to a temperature of about 300° C. for about 3 h in a vacuum.

A loading of the plurality of vanadium oxide nanoparticles may range from about greater than 0 wt % to about 50 wt %. In many embodiments, a loading of the vanadium oxide nanoparticles is less than about 25 wt %. In preferred embodiments, a loading of the plurality of vanadium oxide nanoparticles is about 10 wt %. For example, in a preferred embodiment, a loading of a plurality of vanadium dioxide nanoparticles may be about 10 wt %.

The carrier solvent may include any suitable solvent, such as any solvent compatible with oleic acid. For example, the carrier solvent may include one or more of water and organic solvents. The carrier solvent may include, among other things, one or more of 2-methoxyethanol, 2-ethoxyethanol, chlorobenzene, 1,2-dichlorobenzene, chloroform, diethyl ether, dimethylformamide (DMF), hexane, cyclohexane, tetrahydrofuran (THF), and alcohols (e.g., a short chain alcohol having an alkyl chain of 1-3 carbon atoms). The carrier solvent may include an alkoxy or alkoxy group, such as one or more of a methoxy, ethoxy, propoxy, isopropoxy, n-butoxy, tert-butoxy, pentoxy, hexyloxy, and heptyloxy. In preferred embodiments, the carrier solvent includes a methoxy and/or ethoxy. The carrier solvent may include a halogen or halo group, such as one or more of fluorine, chlorine, bromine, and iodine. In preferred embodiments, the carrier solvent includes chlorine, such as a chloro group. The carrier solvent may include an alcohol, such as a lower alkanol. The alcohol may include one or more of methanol, ethanol, 1-propanol, 2-propanol, n-butanol, i-butanol, t-butanol, propylene glycol, ethylene glycol, and glycerin. In an embodiment, the carrier solvent includes one or more of 2-methoxy ethanol, chlorobenzene, and ethanol. In a preferred embodiment, the carrier solvent includes about 87.5 vol % 2-methoxyethanol, about 7.5 vol % chlorobenzene, and about 5 vol % ethanol. Any one or more of the solvents described above and/or elsewhere may be used herein.

The ink composition may optionally further comprise one or more additives. The additives may include, among others, one or more of HEC, 2-HEC, 2,3-butanediol, glycerol, and ethylene glycol.

The ink composition may exhibit a phase transition. The phase transition may occur, for example, by and/or through the vanadium oxide nanoparticles, such as vanadium dioxide nanoparticles. The phase transition may occur in response to an external stimulus and/or external stimuli, such as one or more of temperature, photo-excitation, hydrostatic pressure, uniaxial stress, and electrical gating. In many embodiments, the phase transition may include an insulator-to-conductor transition in response to a change in temperature (e.g., thermal tuning). The ink composition may exhibit a phase transition point at a critical temperature ranging from about 65° C. to about 70° C. For example at temperatures above the critical temperature, the ink composition may exhibit conductive properties and/or at temperatures below the critical temperature, the ink composition may exhibit insulating properties. The phase transition point upon heating from a low temperature (e.g., a temperature below about the phase transition point) to a high temperature (e.g., a temperature above about the phase transition point) may be about 70° C. The phase transition point upon cooling from a high temperature (e.g., a temperature above about the phase transition point) to a low temperature (e.g., a temperature below about the phase transition point) may be about 65° C. The phase transition (e.g., insulator-to-conductor transition) may be reversible in response to thermal tuning.

A particle size of the vanadium oxide nanoparticles may range from about 50 nm to about 1,000 nm. In a preferred embodiment, a particle size of the vanadium oxide nanoparticles may be about 50 nm. In other embodiments, a particle size of the vanadium oxide nanoparticles may be less than about 50 nm and/or greater than about 1,000 nm. A weight percent of the vanadium oxide nanoparticles (e.g., in the ink) may range from about 2 wt % to about 20 wt %. In a preferred embodiment, a weight of the vanadium oxide nanoparticles may be about 5 wt %. In other embodiments, a weight percent of the vanadium oxide nanoparticles may be less than about 2 wt % and/or greater than about 20 wt %. A viscosity of the ink composition may range from about 1 cps to about 10 cps. A surface tension of the ink composition may range from about 25 mN/m to about 30 mN/m. In a preferred embodiment, a surface tension of the ink composition may be about 28 mN/m.

In an embodiment, the ink composition may comprise a plurality of vanadium dioxide nanoparticles in a monoclinic phase mixed with 2-methoxy ethanol, chlorobenzene, and ethanol. In an embodiment, the ink composition may include about 10 wt % of vanadium dioxide nanoparticles mixed with about 3.5 mL of 2-methoxy ethanol, about 0.3 mL of chlorobenzene, and about 0.2 mL of ethanol.

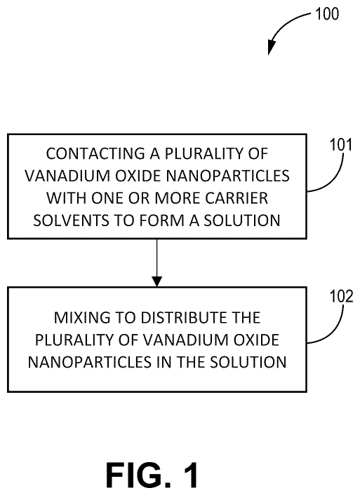

FIG. 1 is a flowchart of a method of preparing an ink composition, according to one or more embodiments of the present disclosure. As shown in FIG. 1, the method 100 may comprise contacting 101 a plurality of vanadium oxide nanoparticles with one or more carrier solvents to form a solution and mixing 102 sufficient to distribute the plurality of vanadium oxide nanoparticles in the solution (e.g., to obtain a dispersion). The method may further optionally comprise filtering 103 the dispersion to separate oversized particle aggregates (not shown).

The step 101 includes contacting a plurality of vanadium oxide nanoparticles with one or more carrier solvents to form a solution. In this step, the plurality of vanadium oxide nanoparticles may be brought into physical contact, or immediate or close proximity, with the one or more carrier solvents. Any of the vanadium oxide nanoparticles and/or carrier solvents of the present disclosure may be used herein. For example, in many embodiments, the plurality of vanadium oxide nanoparticles may include one or more of V₂O₅, V₂O₃, and VO₂. In preferred embodiments, the plurality of vanadium oxide nanoparticles may include vanadium dioxide (VO₂). The carrier solvents may include any suitable solvent. In many embodiments, the carrier may include one or more of an alkoxy, alkanol, and halogen. In preferred embodiments, the carrier includes 2-methoxy ethanol, chlorobenzene, and ethanol.

In some embodiments, the vanadium oxide nanoparticles are substantially produced and/or prepared in a monoclinic phase. In other embodiments, the vanadium oxide nanoparticles may be produced and/or prepared in a mixture of phases, such as VO₂ (M) and VO₂ (A) phases. In these embodiments, the vanadium oxide nanoparticles may be subjected to a treatment and/or pretreatment to obtain vanadium oxide nanoparticles in a single phase. The treatment and/or pretreatment may proceed with as-synthesized vanadium oxide nanoparticles. For example, in an embodiment, the vanadium oxide nanoparticles (e.g., the as-prepared vanadium oxide nanoparticles) may be subjected to annealing in air and/or vacuum to obtain vanadium oxide nanoparticles that are substantially in a VO₂ (M) phase. The annealing may proceed at or to a temperature ranging from about 100° C. to about 500° C. In many embodiments, the annealing may proceed at or to about 200° C. to about 400° C. The annealing may proceed for a period of time ranging from about 1 h to about 6 h. For example, in an embodiment, the annealing of vanadium oxide nanoparticles (e.g., as-prepared vanadium oxide nanoparticles) may proceed at or to a temperature of about 300° C. for about 3 h under vacuum to obtain pure phase VO₂ (M). In many embodiments, the vanadium oxide nanoparticles are subjected to the treatment and/or pretreatment prior to ink formation (e.g., prior to being contacted with one or more carrier solvents). The VO₂ (M) phase may be preferred because this phase gives conductor properties (or transformation to rutile phase) at lower temperature of heat such as about 68° C. In some embodiments, the vanadium oxide nanoparticles may be subject to a treatment and/or pretreatment prior to being contacted with one or more carrier solvents.

The step 102 includes mixing sufficient to distribute the plurality of vanadium oxide nanoparticles in the solution. In this step, the solution may be stirred, among other techniques known in the art (e.g., agitated), to distribute the plurality of vanadium oxide nanoparticles in and/or throughout the solution. In some embodiments, the mixing may be sufficient to create one or more of a mixture, dispersion, and suspension. The mixing may proceed for a suitable duration of time. For example, in many embodiments, the mixing may proceed for about 12 h. In other embodiments, the mixing may proceed for a duration that is less than about 12 h and/or greater than about 12 h.

The step 103 (optional) includes filtering the dispersion to separate oversized particle aggregates. In this step, the mixture may be subjected to filtration to separate oversized particle aggregates to avoid clogging and/or blockage during jetting and/or printing. Oversized particle aggregates may be defined according to the printing application and/or apparatus used for printing. In some embodiments, oversized particle aggregates may include particle aggregates greater than about 450 nm in size. For example, 0.45 μm polypropylene Whatman paper may be used for the filtering. In other embodiments, oversized particle aggregates may include particle aggregates that are less than about and/or greater than about 450 nm in size.

In an embodiment, the method of preparing an ink composition may comprise contacting 101 a plurality of vanadium oxide nanoparticles with one or more carrier solvents to form a solution and mixing 102 sufficient to distribute the plurality of vanadium oxide nanoparticles in the solution. The method may further optionally comprise filtering 103 the dispersion to separate oversized particle aggregates (not shown).

In an embodiment, the method of preparing an ink composition may comprise contacting 101 a plurality of annealed vanadium oxide nanoparticles with one or more carrier solvents to form a solution and mixing 102 sufficient to distribute the plurality of annealed vanadium oxide nanoparticles in the solution. The method may further optionally comprise filtering 103 the dispersion to separate oversized particle aggregates (not shown).

In an embodiment, the method of preparing an ink composition may comprise annealing a plurality of vanadium oxide nanoparticles to obtain pure phase vanadium oxide nanoparticles (e.g., annealed vanadium oxide nanoparticles); contacting 101 the plurality of annealed vanadium oxide nanoparticles with one or more carrier solvents to form a solution, and mixing 102 sufficient to distribute the plurality of annealed vanadium oxide nanoparticles in the solution. The method may further optionally comprise filtering 103 the dispersion to separate oversized particle aggregates (not shown).

In an embodiment, the method of preparing an ink composition may comprise contacting 101 a plurality of vanadium dioxide nanoparticles with 2-methoxy ethanol, chlorobenzene, and ethanol as the carrier solvents to form a solution, and mixing 102 the solution for about 12 h sufficient to distribute the plurality of vanadium dioxide nanoparticles in the solution.

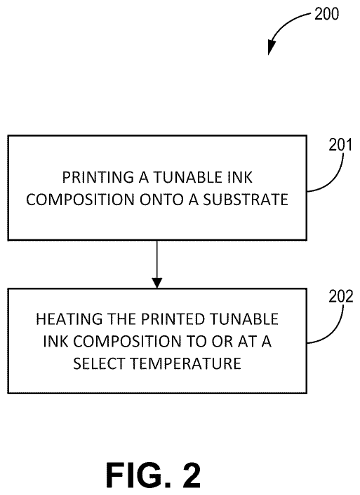

FIG. 2 is a flowchart of a method of printing an ink composition, according to one or more embodiments of the present disclosure. As shown in FIG. 2, the method 200 may comprise printing 201 an ink composition onto a substrate, wherein the ink composition includes a plurality of vanadium oxide nanoparticles and one or more carrier solvents, and heating 202 the printed ink composition to or at a select temperature.

The step 201 includes printing an ink composition onto a substrate, wherein the ink composition includes a plurality of vanadium oxide nanoparticles and one or more carrier solvents. In this step, the ink composition may be ejected and/or deposited onto the substrate in any form and/or pattern. In an embodiment, the print may be ejected as one or more droplets. For example, in an embodiment, the printing may include vertically dropping or ejecting at least one droplet of the ink. The printing may be used to form one or more layers of the ink composition. The printing may proceed in a continuous or batch process, including manufacturing processes, such as additive manufacturing processes and/or printing processes. In an embodiment, the printing may include any technique of printing, such as inkjet printing, 2D printing, and/or 3D printing. In an embodiment, the printer may include a drop-on-demand piezoelectric ink-jet nozzle.

The printing may include printing to form at least one layer of the ink composition on the substrate. The printing may include printing directly onto the substrate such that the ink composition is in physical contact with the substrate. The printing may include printing indirectly onto the substrate, such as printing onto another layer, however deposited and/or printed, on the substrate. In many embodiments, the printing may include printing at least about 1 overlayer, preferably about 5 overlayers, of the ink composition to, for example, achieve a uniform or substantially uniform density of the vanadium oxide nanoparticles. The number of layers of the ink composition printed on the substrate may be selected to achieve a desired thickness. For example, a thickness of the ink composition may be increased by increasing the number of printed layers and/or decreased by decreasing the number of printed layers.

The printing may proceed at a temperature and/or pressure suitable for controlling the spreading of the ink composition directly on the substrate (e.g., ink is in direct contact with the substrate) or indirectly on the substrate (e.g., ink is not in direct contact with the substrate, such as the ink is on another layer of the substrate). In many embodiments, the printing may proceed at about room temperature and/or ambient atmospheric pressure. The temperature and/or pressure may vary depending on the properties and/or characteristics of the ink composition. For example, the ink compositions of the present disclosure may vary in terms of concentration of components, viscosity, particle size, surface tension, density, etc. In some embodiments, the ink composition may include about 10 wt % of vanadium dioxide nanoparticles. In these embodiments, the printing may proceed at about 60° C. or less. In other embodiments, the printing may proceed at a temperature less than about 100° C.

Any of the ink compositions of the present disclosure may be used herein. For example, in an embodiment, the ink composition may include a plurality of vanadium oxide nanoparticles and one or more carriers in a solution or mixture. In an embodiment, the ink composition may include a plurality of vanadium dioxide nanoparticles and one or more carriers in a solution or mixture. The substrate may include any substrate. In many embodiments, the substrate includes any substrate suitable for the ink compositions of the present disclosure. For example, the substrate may include one or more of PI, PET, PEN, glass, and other 3D printed substrates, such as those formed from acrylic and/or molten plastic (acrylonitrile butadiene styrene (ABS), polylactic acid (PLA), etc.) based materials.

The step 202 includes heating the printed ink composition to or at a select temperature. The step 202 may be optional and may be performed to obtain a desired film quality and/or crystal structure of one or more of the vanadium oxide nanoparticles and ink composition. In addition or in the alternative, the step 202 may be performed to evaporate one or more ink solvents. The heating may include increasing a temperature of the printed ink composition and/or an environment of the printed ink composition. The heating may include increasing a temperature to the select temperature and holding for a select period of time, optionally under vacuum. For example, in some embodiments, the heating may include annealing to or at about the select temperature for a select period of time in a vacuum. The select temperature may include any temperature. In many embodiments, the select temperature is greater than about room temperature and/or the printing temperature. For example, the select temperature may range from about 100° C. to about 200° C. In preferred embodiments, the select temperature may be about 200° C. In another preferred embodiment, the heating may include annealing to or at about 200° C. under vacuum for about 1 h. In other embodiments, the select temperature may be less than about and/or greater than about 200° C.

In an embodiment, the method of printing an ink composition comprises printing an ink composition onto a substrate at or to a temperature ranging from about room temperature to about 60° C., wherein the ink composition includes a plurality of vanadium dioxide nanoparticles mixed in 2-methoxy ethanol, chlorobenzene, and ethanol, and heating the printed ink composition to or at about 200° C. for about 1 h under vacuum.

Embodiments of the present disclosure describe RF devices comprising a printed ink composition. Any of the ink compositions of the present disclosure may be used herein. For example, the printed ink composition may include a plurality of vanadium oxide nanoparticles and one or more carrier solvents. The RF devices may include any additional components known in the art to form, among other things, one or more of switches, antennas, phase shifters, modulators, delay lines, filters, matching networks, tunable loads, sensors, and detectors. The additional components may include printed components and/or non-printed components. The RF devices may be characterized as one or more of tunable, switchable, and reconfigurable.

In an embodiment, the RF device may be a RF switch. The RF switch may include a fully printed RF switch comprising a conductive ink printed on a substrate to form a signal line and an ink composition printed on the substrate as a switch. The conductive ink may include any suitable conductive ink, such as a silver-organo-complex (SOC) ink. The SOC ink is described in WO 2017/103797A1, which is hereby incorporated by reference in its entirety. The conductive ink may be printed onto the substrate in one or more layers, or preferably about 12 layers. The substrate may include any suitable substrate, such as a glass substrate. The substrate may include a thickness of about 1 mm. The signal line may include a coplanar waveguide (CPW) transmission line. The ink composition may include any of the ink compositions of present disclosure. The ink composition may be printed on a top surface of the conductive ink in a shunt switch configuration. The ink composition may be printed in one or more layers, or preferably about 20 layers.

In an embodiment, the RF device may be an antenna, such as a fully printed reconfigurable antenna. The RF device may be designed as a frequency reconfigurable PIFA antenna, wherein the ink composition is printed in a gap created in a major arm of the PIFA antenna such that the antenna can operate at a higher frequency when the switch is in an OFF condition (e.g., for a shorter length of antenna). For the ON condition of the switch, the antenna may have a longer length of the arm to operate at a lower frequency. The RF device may include an antenna arm printed with a conductive ink, such as SOC ink. The antenna arm may include a gap, wherein the ink composition is printed in the gap of the antenna arm. A connector, such as a SMA connector, may be mounted on the CPW transmission line.

The following Examples are intended to illustrate the above invention and should not be construed as to narrow its scope. One skilled in the art will readily recognize that the Examiners suggest many other ways in which the invention could be practiced. It should be understand that numerous variations and modifications may be made while remaining within the scope of the invention.

### Example 1

### A Fully Printed Switch Based on VO₂ Ink for Reconfigurable RF Components

Phase-change materials such as chalcogenides and vanadium dioxide provide an interesting alternative as they can tune their electrical properties with temperature or incident light. Among them, vanadium dioxide (VO₂) is an attractive material which exhibits thermal tuning from insulator to conductor transition (ICT) in a reversible fashion. This makes vanadium dioxide a promising material for high speed switching and reconfigurable devices. Recently, vanadium dioxide was used to demonstrate various RF devices, such as reconfigurable antennas and MEMS actuators. In all of these fabrication processes, vanadium dioxide was deposited by the pulsed laser deposition (PLD) technique in an ultra-high vacuum pressure (8×10⁻⁶ Torr) and high temperature (>550° C.) environment. Thus, it makes the fabrication quite complex and expensive.

Vanadium dioxide (VO₂) is an attractive phase change material for reconfigurable or switchable RF components. However, at present, VO₂ must be deposited by expensive and complex thin film microfabrication techniques. With the surge in low cost, additively manufactured or printed components, it would be beneficial to print phase change materials or switches as well. The issue is there are no such functional inks available in the market.

The present Example describes, for the first time, a VO₂-based ink that changed its conductive properties based on temperature. The VO₂-based ink displayed insulating properties at about room temperature (e.g., a resistance of ˜5KΩ in the off-state), but conductive properties when heated to or at about 70° C. (e.g., a resistance of ˜10Ω in the on-state). Based on this VO₂ ink and a custom silver-organo-complex (SOC) ink, a fully printed thermally controlled RF switch was demonstrated as described herein. In a CPW-based shunt configuration, the fully printed switch provided more than 15 dBs of isolation (e.g., in the off state) and a 0.5-2 dB of insertion loss (e.g., in the on state) from 100 MHz to 30 GHZ frequency band. To demonstrate its application, a fully printed frequency reconfigurable planar inverted F antenna (PIFA) was also demonstrated, as described herein.

A novel VO₂ nanoparticles based ink that can be thermally tuned for its electrical properties is presented. DC characterization of the ink revealed insulating properties at about room temperature (e.g., resistance of ˜5KΩ in the off-state), and conductive properties when heated around 70° C. (e.g., resistance of ˜10Ω in the on-state). Based on this VO₂ ink and a custom silver-organo-complex (SOC) ink, a fully printed thermally controlled RF switch was demonstrated. In a coplanar waveguide (CPW) based shunt configuration, the fully printed switch provided more than about 15 dBs of isolation (e.g., in the off state) and about a 0.5-2 dB of insertion loss (e.g., in the on state) from 100 MHz to 30 GHz frequency band. In order to show the utility of the printed switch, it was used in a frequency reconfigurable PIFA antenna that was capable of switching its frequency from about 2.4 GHz to about 3.5 GHz through thermal activation of the printed switch. The performance of this extremely low cost switch was encouraging and thus can be used for a number of tunable and reconfigurable applications.

### Materials and Switch Configuration

Preparation of VO₂ Nanoparticles: VO₂ was prepared in the form of nanoparticles by a simple solution process. VO₂ nanoparticles were prepared by solution process. In a synthesis process, about 0.5 g vanadium penta oxide (V₂O₅) was stirred in 150 ml 0.15 M oxalic acid. The resultant yellow slurry was then transferred into a 200 ml PPL high-temperature polymer-liner-based hydrothermal autoclave reactor. The reaction temperature and duration may generally range from about 200° C. to about 300° C. and about 3 h to about 24 h, respectively. Here, the reaction temperature was set at 240° C. for 24 h. After the completion of the reaction, the resultant black color precipitate was washed with water and ethanol and then dried in a vacuum at 70° C. for 6 h.

In another synthesis process, 2.445 g vanadium (iv) oxide sulfate hydrate (0.1 M) was dissolved in 150 ml DI water, followed by the addition of 1.8 g urea. The resultant mixture was mixed well, and then 0.9 ml hydrazine hydrate (10% hydrazine hydrate solution in water) was added drop-wise, with stirring. The final solution was then transferred into a 200 ml PPL high-temperature polymer-liner-based hydrothermal autoclave reactor. The reaction temperature was set at 260° C. for 24 h. After the completion of the reaction, the resultant black color precipitate was washed with water and ethanol and then dried in a vacuum at 70° C. for 6 h.

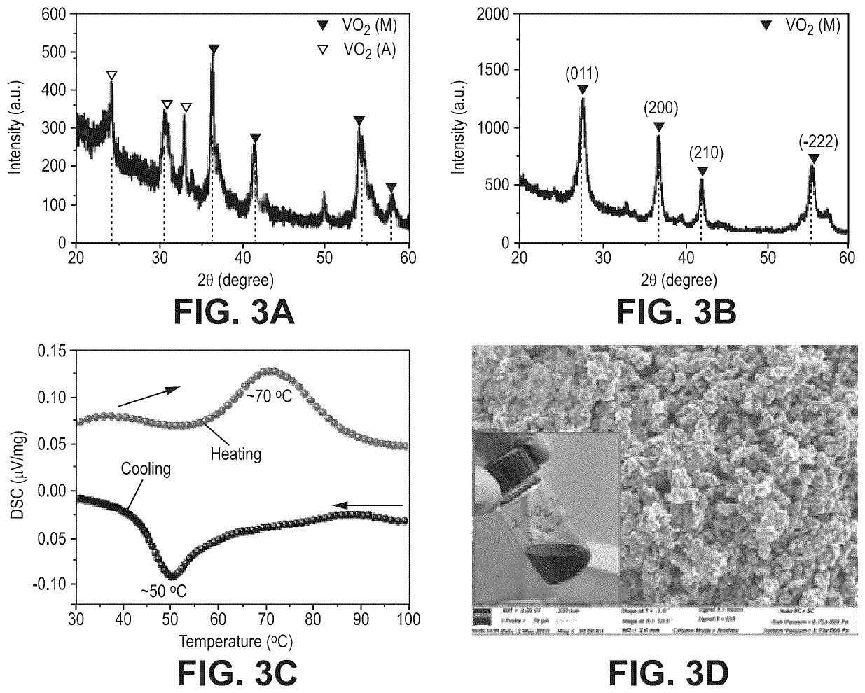

After the preparation of VO₂ nanoparticles, the crystalline phase was characterized by X-ray diffraction (XRD) analysis. It was observed that as-synthesized VO₂ nanoparticles comprised a mixture of VO₂ (A) and VO₂ (M) phases, as shown in FIG. 3A. However, the required phase was the monoclinic VO₂ phase, which shows only the metal-insulator transition at ˜68° C. To get a pure VO₂ (M) phase, different annealing conditions, such as annealing in air and vacuum, were investigated. Finally, a pure phase was achieved after annealing the nanoparticles at 300° C. for 3 h in vacuum, as shown in FIG. 3B. The annealing temperature and duration may range from about 200° C. to about 400° C. and about 1 h to about 6 h, respectively. The XRD peaks in FIG. 3B can be indexed to VO₂ (M) phase. The reversible phase transition of the VO₂ nanoparticles was further confirmed by differential scanning calorimetry (DSC), as shown in FIG. 3C. The exothermic peak indicates an MIT temperature at ˜70° C. during heating, and ˜50° C. during the cooling cycle. The DSC analysis confirms the first-order phase transition from monoclinic to tetragonal with temperature. FIG. 3D shows the morphology of annealed VO₂ nanoparticles which are primarily spherical and aggregated with average particle size smaller than 100 nm. For the ink-formulation, annealed VO₂ nanoparticles were treated with oleic acid to make them compatible with organic solvents, and were then dispersed in the mixture of 3.5 ml 2-methoxy ethanol, 0.3 ml chlorobenzene and 0.2 ml ethanol. The resulting ink solution, as shown in the inset of FIG. 1 (d), was then stirred for 24 h. Subsequently, the formulated ink was filtered by 0.45 μm polypropylene (PP) Whatman paper before jetting.

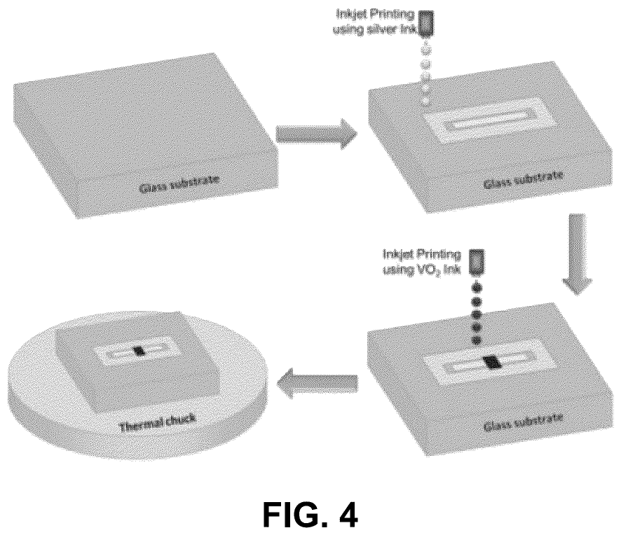

VO₂ material has many crystalline structure phases, however, the preferable phase was monoclinic VO₂ (M), which has the ability to show low temperature (e.g., at about 68° C.) phase transition. To obtain the VO₂ (M) phase, as-prepared nanoparticles were optimized with annealing condition, such as about 200° C. for about 1 h in vacuum. The vanadium dioxide ink was prepared by mixing about 10 wt % VO₂ nanoparticles in about 3.5 ml 2-methoxy ethanol, about 0.3 ml chlorobenzene and about 0.2 ml ethanol. The resultant mixture was stirred for about 12 h before printing. The SOC metallic ink was prepared as previously reported. The particle-free SOC ink was preferred over nanoparticles based ink due to its long-term storage and excellent jetting stability without any clogging issue. As shown in FIG. 4, the stack-up consisted of printing SOC ink on glass substrate (which was an arbitrary choice and it can be replaced with any other substrate). In this particular case, a CPW line was printed through SOC ink. VO₂ was printed on top of the silver ink (e.g., covering the signal and ground traces) to form a shunt switch configuration.

### Printing Process

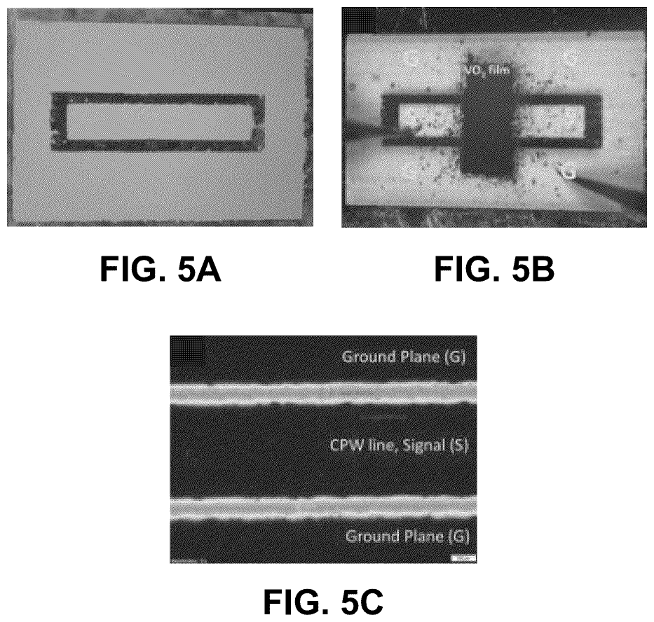

As a first step, a glass substrate with thickness of about 1 mm was taken which was pre-cleaned with water, ethanol, and IPA before printing CPW lines. The metallic 50Ω CPW transmission line was inkjet-printed on glass substrate using SOC based ink with precise line to line gap. A total of 12 layers of SOC ink with drop-spacing of about 30 μm were printed and cured using infrared heating. The devices were designed to interface with 3-terminal, ground-signal-ground (GSG) microwave probes and were arranged in a 2-port series configuration (shown in FIGS. 5A-5C). The VO₂ ink was printed with an area of 0.5×1 mm in a digital fashion in between the CPW line and ground plane, as shown in FIG. 5B. To control the spreading of the VO₂ ink on the surface of CPW line, the printing was performed with a platen temperature of about 60° C. A total of 20 layers of VO₂ ink using DS of about 20 μm were printed. The final fabricated module was heated at 200° C. for about 1 h in vacuum to attain the desired film quality.

Two prototypes were fabricated as shown in FIGS. 5A-5C. The first prototype was only a CPW line which acted as a reference structure (FIG. 5A) and CPW line with printed VO₂ that acted as a switch (FIG. 5B). The signal line in the CPW had a length of about 2 mm, width of about 340 μm, and the gap between signal and ground was about 73 μm. Through careful control in printing parameters, fine and uniform gaps were achieved, as shown in FIG. 5C.

### DC Characterization of VO₂ Printed Film

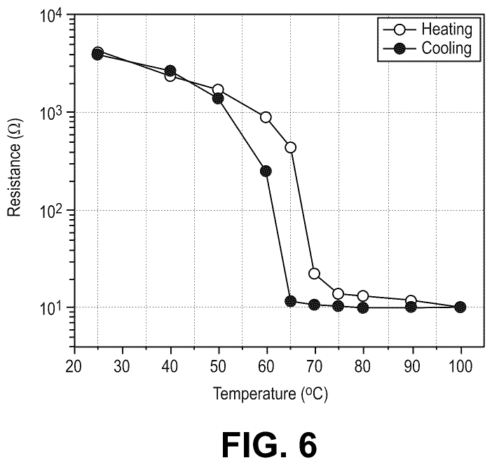

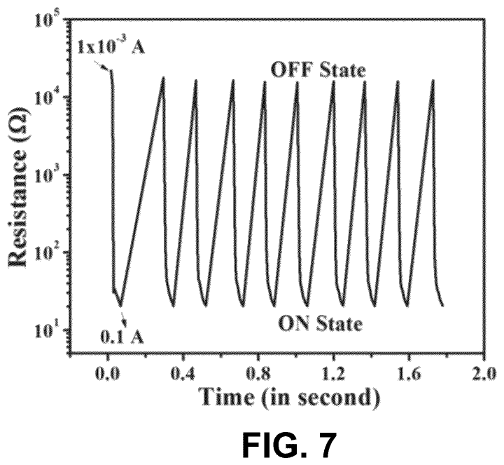

For the Dc characterization, current-voltage (I-V) measurements were performed to extract the resistance of the inkjet-printed VO₂ film (L=74+1 μm and W=500 μm) during ICT by varying the temperature on a thermal chuck, as shown in FIG. 5B. I-V measurements were performed using a Keysight B2912A precision source meter on a hot chuck probe station capable of temperature control from about 5-200° C. The resistance was extracted by taking the inverse slope of IV measurements in the linear low voltage regime where the voltage was swept between +1 V. In order to test the electrical tuning capability, the temperature of hot-chuck was varied from about room temperature to about 100° C. At about room temperature, the resistance was around 5KΩ, which almost showed an insulating behavior. As the temperature was increased to about 50° C., a slight change in the resistance was observed. At about 65° C., the resistance of the printed VO₂ film started to decrease swiftly, as shown in FIG. 6. Increasing the temperature beyond this point further reduced the resistance. At temperatures from about 70 to about 100° C., the resistance became constant at a value around 10Ω. When the temperature was reversed from high temperature to low temperature (cooling stage), the resistance recovered its initial value. The resistance changed by three orders of magnitude from room temperature to the conducting phase, with the phase transition occurring at ˜70° C. during heating cycle and about 65° C. during the cooling cycle. Electrical switching for printed VO₂ film was also characterized, as shown in FIG. 7. It was clearly seen in the graph that with very low current (1×10-3 A), film showed kilo ohm resistance that meant it was still in an OFF state. Increasing the current reduced the resistance further and reached a resistance of around 20Ω with about 100 mA current. As compare to thermal switching, electrical switching was much faster and retained its resistance to original position. With 10 cycle measurement, resistance was almost constant during ON and OFF state. From this characterization, it was deduced that the printed VO₂ film has similar conductor-insulator transition characteristics as reported before. While not wishing to be bound to a theory, two mechanisms were believed to be responsible for the phase transition: i) Peierls mechanisms that are based on electron phonon interactions and ii) Mott-Hubard transition which was based on the strong electron-electron interactions.

### RF Characterization of Printed Switches

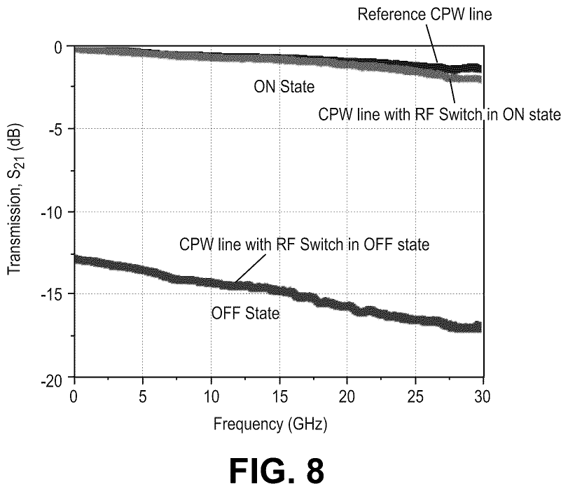

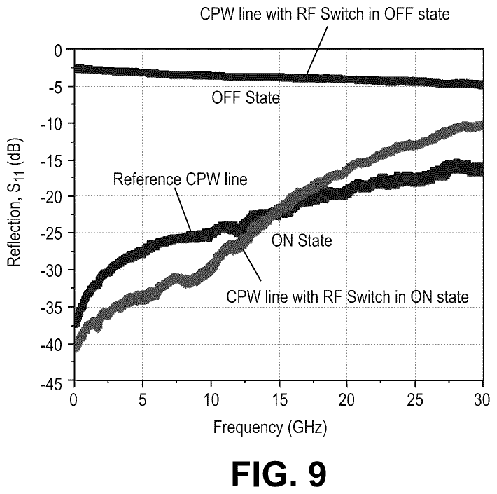

As mentioned in the fabrication section, two CPW lines were printed, one without the VO₂ switch and the other with the VO₂ switch. First, the printed CPW line (without the VO₂ switch) was tested for its S-parameters to act as a reference for the VO₂ RF switch measurements. The RF measurement was done on a Cascade probe station with 500 μm pitch Ground-Signal-Ground (GSG) probes. The measured transmission, S₂₁ and reflection, Su for both the reference CPW line and the shunt switch based CPW line are shown in FIG. 8 and FIG. 9, respectively. It was seen in FIG. 9 that CPW line showed decent transmission in the frequency range from about 100 MHz to about 30 GHZ, when the RF switch was in the ON condition (e.g., VO₂ film was in insulator mode at about room temperature). There was about 0.5 dB of insertion loss from about 100 MHz to about 5 GHZ and as the frequency increased from about 5 to about 20 GHz, the loss increased to about 1 dB. Finally, a loss of ˜2 dB was observed in the frequency range of about 20-30 GHz. It was important to note that the printed VO₂ film on the CPW line did not induce any additional loss as compared to the reference CPW line. When the temperature was increased beyond the phase transition point (e.g., about 70° C.), the VO₂ film transitioned into the conductive mode and short circuited the signal trace to the ground. Thus, transmission levels dropped to around −15 dBs, which represented the OFF state of the RF switch (e.g., VO₂ film was in conductive mode beyond phase transition temperature). The OFF state will be further improved, i.e., decreasing the transmission below about-20 dBs, by simply increasing the thickness of the VO₂ film or by decreasing its planar dimensions. The matching of the CPW line stayed below about −10 dBs for the entire bandwidth, in the ON state of the RF switch, which was important as the transmission was happening in that state (as can be seen in FIG. 9). When the RF switch was OFF, then the matching condition changed, however, this was not a concern as no transmission happened in this state.

### Fully Printed Reconfigurable Antenna

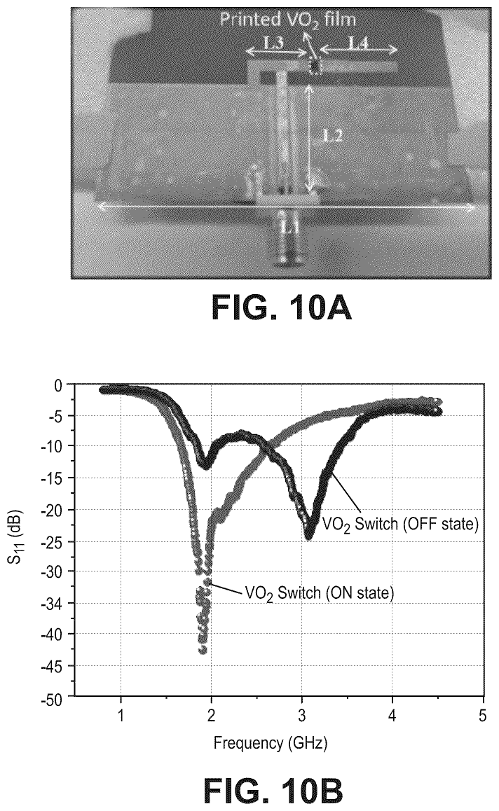

After validation of the RF switch functionality, it was used in the design of a frequency re-configurable PIFA antenna, as shown in FIG. 10A. The VO₂ switch was printed in a gap that was created in the major arm of the PIFA so that the antenna could operate at a higher frequency when the switch was OFF (e.g., for shorter length of antenna). For the ON condition of the switch, the antenna had a longer length of the arm and thus operated at a lower frequency. The prototype of the antenna was printed utilizing a silver-organ complex (SOC) ink with dimensions of (mm): L1=60, L2=21, L3=11.8, L4=15.2, and with the gap between L3 and L4 to be about 0.2 mm. In this particular case, a total of 8 layers of SOC ink were printed and cured using infrared (IR) heating for about 5 min. As can be seen, the VO₂ was printed in between the gap of the antenna arm. The SMA was mounted on the coplanar waveguide line. The Sn of the antenna, as shown in FIG. 10B, was less than about-10 dB in the frequency band of 2.57-3.47 GHz when the switch was at “OFF” state, and in the frequency band of 1.65-2.60 GHz when at “ON” state.

In conclusion, a novel VO₂ nanoparticles based phase change ink was described that may be thermally tuned for its electrical properties. To demonstrate the phase change behavior of printed VO₂ film, a dc-characterization was conducted. At room temperature, printed VO₂ film showed a resistance of around 5KΩ, which almost acted as an insulator. When the temperature reached beyond transition temperature, the printed film showed the resistance in tens of ohm and acted as a conductor. Based on this VO₂ ink and a custom silver-organo-complex (SOC) ink, a fully printed process for shunt-configuration based switching and reconfigurable antenna was demonstrated. Temperature activated switching was obtained with relatively low losses and more than about 15 dB isolation between ON/OFF states, on a broad bandwidth (e.g., about 100 MHZ-30 GHz). It was believed that isolation was improved further by increasing the thickness of the VO₂ film or by decreasing its planar dimensions. The antenna was matched for WiFi (2.45 GHZ) and 5G (3.5 GHZ) bands when the switch was at “ON” or “OFF” state. The switching performance confirmed that printed VO₂ can be very useful for implementation of several tunable and reconfigurable microwave designs.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

What is claimed is:

1. A method for preparing an ink composition, the method comprising:
preparing a plurality of vanadium oxide nanoparticles, wherein the plurality of vanadium oxide nanoparticles includes VO₂ (A) and VO₂ (M) phase nanoparticles;
annealing the plurality of vanadium oxide nanoparticles sufficient to prepare substantially pure VO₂ (M) phase nanoparticles, wherein annealing proceeds at a temperature ranging from about 200° C. to about 400° C.; and
mixing the substantially pure VO₂ (M) phase nanoparticles with one or more carrier solvents.

2. The method of claim 1, wherein annealing includes subjecting the plurality of vanadium oxide nanoparticles to annealing under vacuum.

3. The method of claim 1, wherein annealing is performed for about 1 hour to about 6 hours.

4. The method of claim 1, wherein annealing is performed under vacuum at a temperature of about 300° C.

5. The method of claim 1, wherein annealing is performed under vacuum at a temperature of about 200° C. for about 1 hour.

6. The method of claim 1, wherein mixing the substantially pure VO₂ (M) phase nanoparticles with one or more carrier solvents is sufficient to form a solution.

7. The method of claim 6 further comprising stirring the solution to distribute the substantially pure VO₂ (M) phase nanoparticles and to form a dispersion.

8. The method of claim 7 further comprising filtering the dispersion sufficient to separate oversized particle aggregates.

9. The method of claim 8, wherein the oversized particle aggregates include particle aggregates greater than about 450 nm in size.

10. The method of claim 7, wherein a viscosity of the dispersion ranges from about 1 mPa·s to about 10 mPa·s.

11. The method of claim 1, wherein the one or more carrier solvents include at least one of 2-methoxy ethanol, chlorobenzene, and ethanol.

12. The method of claim 1, wherein a weight percentage of substantially pure VO₂ (M) phase nanoparticles in the one or more carrier solvents ranges from about 2 wt. % to about 20 wt. %.

13. The method of claim 1 further comprising treating the substantially pure VO₂ (M) phase nanoparticles with oleic acid prior to mixing the substantially pure VO₂ (M) phase nanoparticles with one or more carrier solvents.

14. The method of claim 1, wherein preparing the plurality of vanadium oxide nanoparticles includes performing a reaction to form the VO₂ (A) and VO₂ (M) phase nanoparticles, wherein the reaction is performed for about 3 hours to about 24 hours.

15. The method of claim 14, wherein the reaction is performed at a temperature ranging from about 200° C. to about 300° C.

16. A method for preparing an ink composition, the method comprising:
annealing a plurality of vanadium oxide nanoparticles sufficient to prepare substantially pure VO₂ (M) phase nanoparticles, wherein annealing proceeds at a temperature ranging from about 200° C. to about 400° C., and wherein the substantially pure VO₂ (M) phase nanoparticles have an average particle size of less than 100 nm; and
mixing the substantially pure VO₂ (M) phase nanoparticles with one or more carrier solvents.

17. The method of claim 16, wherein annealing includes subjecting the plurality of vanadium oxide nanoparticles to annealing under vacuum.

18. The method of claim 16, wherein annealing is performed for about 1 hour to about 6 hours.

19. The method of claim 16, wherein annealing is performed under vacuum at a temperature of about 300° C. for about 3 hours.

20. The method of claim 16, wherein the one or more carrier solvents include at least one of 2-methoxy ethanol, chlorobenzene, and ethanol.
